(19) United States
(12) Patent Application Publication
(10) Pub. No.: US 2006/0048900 A1
(43) Pub. Date: Mar. 9, 2006

(54) Method and device for connecting two-dimensional materials

(76) Inventors: Christian Welter, Oberburen (CH); Peter Busenhart, Wiesendangen (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/219,331

(22) Filed: Sep. 2, 2005

(30) Foreign Application Priority Data
Sep. 3, 2004 (CH) 1459/04

(51) Int. Cl. B32B 37/00; B29C 65/00

(52) U.S. Cl. 156/550; 156/324; 156/543; 156/547; 156/549

(57) ABSTRACT

In the device (1) for connecting two-dimensional materials (51, 52), a first material web (51) is coated with a hot-melt mass in a hot-melt mass deposition station. The first material web (51) is subsequently contacted with a second material web (52). The contact between the two material webs (52) is fixed in a belt press (30). Thus the processing of combinations of materials and adhesives which until now were not or hardly considered at all become possible. The material webs (51, 52) are treated in a gentle manner. An improved connection quality at a higher processing speed is achieved. A greater field of application becomes accessible in that the processing window is extended with regard to the parameters of pressure time and temperatures is extended.

### BACKGROUND OF THE INVENTION

The present invention relates to a method and to a device for connecting two-dimensional materials, in particular material webs of preferably textile materials, according to the preambles of the independent patent claims.

It is known to coat a two-dimensional material with a hot-melt mass—also called hotmelt. A bonding to a second material web may occur directly subsequent to this, wherein the two material webs are joined together in a roller laminating mill. Thus e.g. two textile material webs may be joined together with a hot-melt adhesive. This method however is unsuitable for thick materials and materials which are elastic in thickness, such as foams and bulk nonwovens, since these are pressed together in a roller laminating mill, and the connection is damaged due to shearing and tearing. Moreover, with many highly viscous adhesives, the residence time or the press time in the roller laminating mill is too short for the hot-melt adhesive to be able anchor in the material webs.

Furthermore, belt presses are known, by way of which two sheet formations are to be connected or laminated amid the application of heat and pressure. A bonding mass is used for bonding, which usually itself has the shape of a sheet formation.

### SUMMARY OF THE INVENTION

It is the object of the invention to specify a method and a device for connecting two-dimensional materials which permit new applications and a greater freedom with regard to the applied adhesive. A good connection quality is to be achieved at a high processing speed. A gentle treatment of the materials to be connected is to be ensured. The device should have a compact construction and should also be suitable for retrofitting existing installations.

These and other objects are achieved by the method according to the invention and the device according to the invention, as are defined in the independent patent claims. Advantageous embodiments of the method and of the device are specified in the dependent patent claims.

The invention is based on the idea of combining a holt-melt mass deposition station with a belt press station, or combining the methods implemented in these.

Accordingly, in the method according to the invention for connecting two-dimensional materials, a surface of a first, two-dimensional material is coated with a hot-melt mass and is brought into contact with a surface of a second, two-dimensional material. The contact between the two two-dimensional materials is fixed in a belt press.

The device according to the invention for connecting two-dimensional materials contains coating means for coating a surface of a first two-dimensional material with a hot-melt mass, and contacting means for contacting the coated surface of the first, two-dimensional material with a surface of a second, two-dimensional material. Furthermore, the device contains a belt press for fixing the contact between the two two-dimensional materials.

The coating means may comprise a rotation deposition body, e.g., a gravure roller or a rotation screen printing stencil. In a preferred embodiment of the invention, the relative speed of the gravure roller to the material web is variable. This characteristic permits the same gravure roller to be used in a multitude of applications without having to exchange the gravure roller. A great flexibility is achieved by way of this. The conversion times are significantly reduced, since an exchange of the gravure roller is done away with, which in turn has a cost-reducing effect. One may also retain one and the same gravure roller during a conversion to another application in the coating module at a high temperature, by which means a curing of the hot-melt mass on the gravure roller is avoided. The deposition weight (in this document this is to be understood as the deposited mass per area; also called coating thickness) in this embodiment is determined by the relative speed between the gravure roller and the material web which runs past. The relative speed may be positive or negative. The change of the relative speed may e.g. be achieved by a change in the rotational speed of the gravure roller. In a preferred embodiment, not only the rotational speed but also the rotational direction of the gravure roller may be changed. By way of this, one may change the relative speed and so too the deposition weight by a factor of 100 without any problem. The change and [closed-loop] control of the rotational speed is less demanding with regard to technology than the change and the [closed-loop] control of a distance of hot rollers. This advantage particularly makes a difference when dealing with hot-melt mass, where the temperature conditions render an accurate control of the distances considerably more difficult. Furthermore, the dosing of the hot-melt mass is effected with a very simple doctor system which ensures a very uniform preparation of the hot-melt mass in the longitudinal and transverse direction.

Until now, gravure rollers have been used in the application of hot-melt mass coating/laminating with an approximately slip-free synchronous running with the material web, for a 1:1 transfer of the gravure pattern onto the material web. The preferred embodiment of the present invention upsets this basic principle, in that it permits an asynchronous running and thus a rubbing of the gravure pattern on the material web. This rubbing effect in the context of gravure rollers was completely undesirable with the holt-melt method until now, since a deposition true to gravure was to be achieved. The present invention opens completely new possibilities also in this aspect in that, as previously the case, it permits a transfer of the gravure pattern (with the same speed of the gravure roller and the material web), but also permits its rubbing up to a homogeneous coating of the material web (at greatly different speeds). With this, the relative speed between the gravure roller surface and the material web determines the intensity of the rubbing or transfer.

The invention permits access to a wider field of application in that it widens the processing window with regard to the parameters of pressure, time and temperature.

Thanks to the invention, the processing of combinations of materials and adhesives which until now were not considered or hardly considered becomes possible. The two-dimensional materials are treated in a gentle manner, since various variable heating and/or cooling zones may be provided along a longer path in the belt press station, so that the two-dimensional materials may be heated or cooled with a lower intensity and do not suffer any temperature shocks. An improved connection quality is achieved at a higher processing speed.

The device according to the invention is preferably designed in a modular construction manner. This means that at least one autonomous hot-melt module and one autonomous belt press module are present, which in each case comprise a well-defined interface for the transfer of a coated, two-dimensional material. In this context, “autonomous” means that the modules in each case are capable of being applied on their own, independently of one another. The modular construction manner offers the additional advantage that the two modules may also be operated individually or together with further modules. A multi-functional solution with a large field of application is provided by way of this. This covers the requirement of a greater flexibility in the material selection and the functions of the manufactured textile laminates and coated substrates, and entails a reduction of costs. This feature is particularly attractive for contract manufacturers or piecework manufacturers, who are required to convert their production installation to the requirements of different customers within the shortest time.

### BRIEF DESCRIPTION OF THE DRAWINGS

One preferred embodiment of the invention is explained in a detailed manner by way of the accompanying drawings. There are schematically shown in:

FIG. 1 the device according to the invention, in an opened lateral view and

FIG. 2 the device according to the invention, in a perspective view.

### DETAILED DESCRIPTION OF THE INVENTION

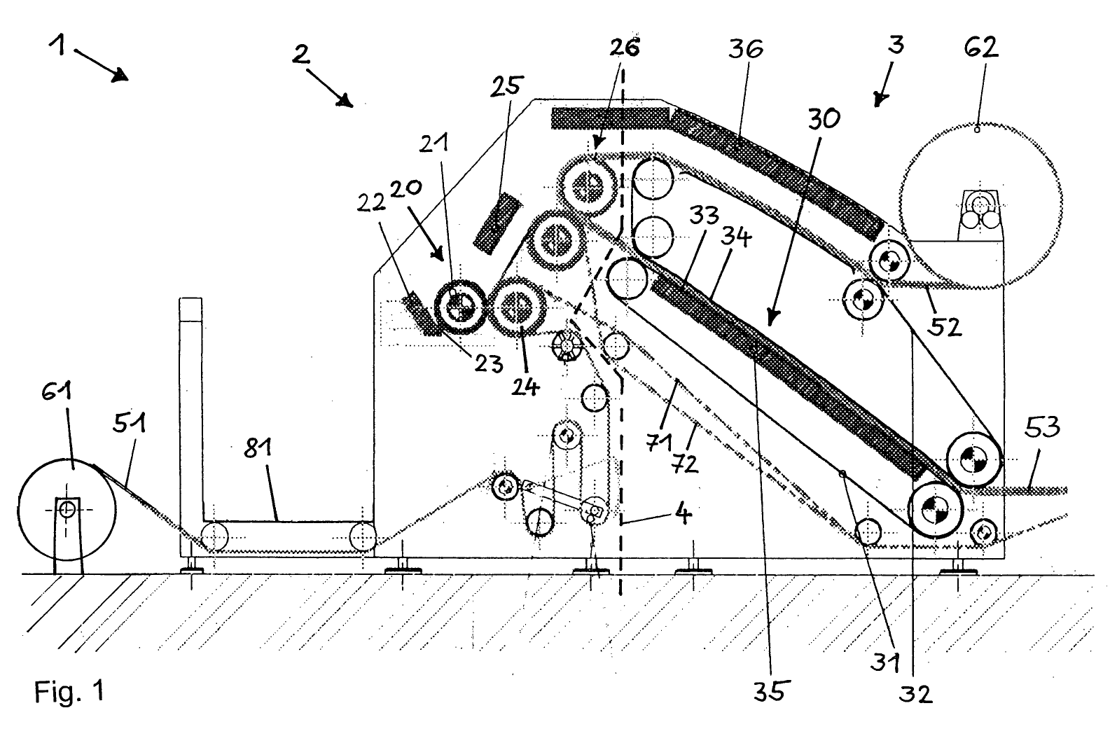

The preferred embodiment of the device 1 according to the invention shown in the drawings contains two modules: an autonomous hot-melt module 2 and an autonomous belt-press module 3. A delimitation between the two modules is indicated in FIG. 1 with a dashed line 4. Each module 2, 3 comprises a well-defined interface for the transfer of a coated, two-dimensional material 51.

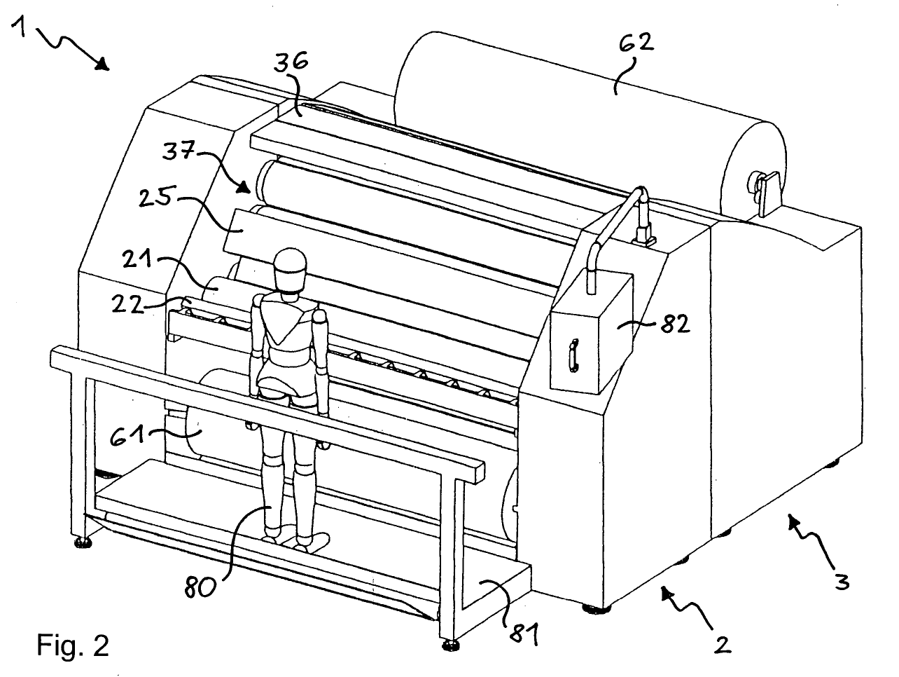

The hot-melt module 2 serves for coating a first, two-dimensional material or substrate 51 with a hot-melt mass. The first, two-dimensional material 51 in the represented embodiment is a flexible material web which is unwound from a first contact unwinder 61 and is led to a hot-melt mass deposition station 20 via various rollers. A dancer for compensating the tension and/or a cord stretching means for spreading the material web 51 may be present, as is known from the state of the art. The first contact unwinder 61 may be arranged outside the hot-melt module 2 (cf. FIG. 1) or within the hot-melt module 2 (alternative; cf. FIG. 2).

In the shown embodiments, the hot-melt mass deposition station 20 is equipped with a gravure roller 21 whose surface—peripheral surface to be more accurate—is provided with recesses for receiving hot-melt mass. The recesses are preferably arranged in a regular pattern and are designed for example as truncated pyramids, diagonal grooves, grooves arranged a net-like manner or a hatching. The surface density of the hot-melt mass accommodated by the gravure roller 21 may for example be 5-100 g/m² and preferably 10-40 g/m². The surface of the gravure roller 21 is heatable and is preferably [closed-loop] controlled with regard to temperature, so that the hot-melt mass located in the recesses of the gravure roller 21 may be kept exactly at the required temperature. With thermoplastic adhesives, this temperature is typically 220-240° C. The surface of the gravure roller 21 is preferably metallic, for example of chromium, but may also be non-metallic.

In one preferred embodiment of the invention, the relative speed of the gravure roller 21 to the material web 51 is variable in the hot-melt mass deposition station 20. This relative speed may be positive or negative. The change of the relative speed may e.g. be achieved by a change of the rotational speed of the gravure roller 21. Preferably not only may the rotational speed be changed, but also the rotational direction of the gravure roller 21.

The hot-melt mass is introduced into the recesses in the surface of the gravure roller 21 for example via a heated doctor beam 22 by way of a doctor blade 23. In order to take both possible rotational directions of the gravure roller 21 into account, the doctor blade 23 may be adjustable according to the rotational direction, or a second doctor blade for the other rotational direction may be provided (not drawn in).

A counter roller 24 is attached in the direct vicinity of the gravure roller 21, and the material web 51 bears on this counter roller 24 in a slip-free manner and party wraps around this. The counter-roller 24 is preferably formed of a siliconized rubber roller, but may e.g. also consist of steel and be coated with chromium or Teflon. The axes of the gravure roller 21 and the counter roller 24 run parallel to one another, and the surfaces of the gravure roller 21 and the counter roller 24 have a well-defined distance to one another. The distance is preferably mechanically and/or electrically adjustable, for example by way of an electric motor. It is preferably between −0.5 mm and +10 mm depending on the thickness and the nature of the material web 5, wherein a negative distance means that the surface of the counter roller 24 is reversibly deformed, i.e. pressed in, due to the less flexible gravure roller 21. The distance determines the bearing pressure of the material web 51 on the gravure roller 21. The counter roller 24 may be equipped with its own drive. Otherwise, another drive roller may accomplish the transport of the material web 51.

The gravure roller 21 has a drive means (not drawn), for example its own electro-motor drive which is independent of that of the counter roller 24, and in particular a servo motor or direct current motor, by way of which it may be set into rotation with a settable rotational speed. The rotational speed is kept constant during a coating procedure, but this is not absolutely necessary. The desired deposition speed is determined by way of the relative speed V_{G}-V_{T} between the surface of the gravure roller 21 and the material web 51, which for example is between 2 g/m² and 200 g/m² and preferably between 10 g/m² and 100 g/m². In order to be able to achieve a large scope of deposition speeds with one and the same device, the rotational speed of the gravure roller 21 should be able to be changed in an as large as possible range. The ratio V_{G}/V_{T} of the speed V_{G} Of the surface of the gravure roller 21 to the transport speed V_{T} of the material web 51 should preferably be able to be selected between 0.1 and 10. In a preferred embodiment, a rotation of the gravure roller 21 in both directions is possible, by which means even high relative speeds V_{G}-V_{T} may be obtained. With a counter-running, the ratio V_{G}/V_{T} of the speed V_{G} of the surface of the gravure roller 21 to the transport speed V_{T} of the material web 51 should preferably be able to be selected between −0.2 and −5.

A post-heating element 24 which is arranged downstream of the hot-melt mass deposition station 20 ensures that the deposited hot-melt mass does not cool to below a lower limit temperature of for example 160°, or heats it to a temperature which is even higher than the deposition temperature, in order to create optimal conditions for the connecting. The post-heating element 25 may for example be designed as an infrared radiator.

In the present embodiment example a calendar 26 with preferably two calendar rollers is provided at the exit of the hot-melt module 2. The two material webs 51, 52 are deflected in this calendar 26 and are brought into contact with one another for the first time. Additionally, the two material webs 51, 52 are fixed onto one another in the calendar 26 and thus are prepared for the subsequent treatment in the belt press module 3. Such a calendar 26 arranged downstream is however purely facultative. The material webs 51, 52 could also be brought into contact only until in a belt press station 30.

The gravure roller 21 is only one of several possible embodiment examples for the design of the hot-melt mass deposition stations 20. Further embodiment forms of the device 1 according to the invention, alternatively to the gravure roller 21 may be the following hot-melt mass deposition systems which are known to the man skilled in the art:
(i) Slot die. With this, a complete-surfaced homogeneous coating of the material web 51 may be achieved. The deposition weight may be influenced via the exit speed of the hot-melt mass and/or via the transport speed of the material web 51.
(ii) Multi-roll coating. The hot-melt mass is deposited onto the smooth surface of an unstructured deposition roller by way of a heated roller dosing mill and is transferred by this deposition roller onto the material web. A complete-surfaced coating of the material web 51 is achieved. The parameters for influencing the deposition weight are the distance between the deposition roller and the material web 51 (or a counter roller on which the material web bears) as well as the relative speed between the deposition roller and the material web 51.
(iii) Rotation screening printing
(iv) Melt-blow method

In the belt press module 3, the first, two-dimensional material or substrate 51 which is coated with the hot-melt mass is connected to a second, two-dimensional material or substrate 52 into a laminate 53. The second, two-dimensional material 52 may e.g. be a flexible material web which is led from a second contact unwinder 62 to the first, two-dimensional material 51. It is advantageous to preheat the second, two-dimensional material 52 to a suitable temperature, for example in the region of the fixation temperature which for thermoplasts for example is approx. 160° C., before the joining-together. A preheat element 36, for example an infrared radiator may be provided for this purpose.

The belt press module 3 contains two transport belts or conveyor belts 31, 32 which are arranged essentially above one another. In a belt press station 30, two belt faces 33, 34 of the transport belts 31, 32 are directed facing one another and run essentially parallel to one another. Between these belt faces 33, 34, the two two-dimensional material 51, 52 amid the application of heat and pressure are connected or fixed to one another by way of the hot-melt mass already deposited on the first, two-dimensional material 51.

The heat may be supplied by way of at least one press heating element 35. Such a press heat element 35 may e.g. consist of several elongate heating profiles which are arranged next to one another in the transport direction at a small distance. With regard to their direction of longitudinal extension, the elongate heating profiles are aligned transversely to the transport direction. In FIG. 1, for the sake of simplicity, a press heating element 35 is allocated to only one belt face 33, but analogously a press heating element may also be allocated to an upper belt face 34. Likewise, cooling elements (not shown) may be provided in the region of the belt press station 30. With a suitable sequence of press heating elements and/or cooling elements, one may influence or control the temperature of the laminate 53 along its length and/or width in a targeted manner. The laminate 53 may thus run through a temperature profile which is well defined with regard to time. In FIG. 1, only a single press heating element 35 within the belt press station 30 is drawn in for representation. However, further elements influencing the temperature are possible within the belt press module 3. With this, it may be the case of heating and/or cooling elements which may be attached within or outside the actual belt press station 30. The laminate is treated in a gentle manner by way of the provision of several heating and/or cooling zones distributed over an as large as possible length, in that it may be treated with lower heating intensities and the transitions between the various temperatures may last longer.

The belt faces 33, 34 of the belt press station 30 may have a straight course, a simple curved course (e.g. circular-arc-shaped, as shown in FIG. 1), a multiple-curved course (e.g. S-shaped) or a combination of these. A curved course may have the advantage that with flexible substrates 51, 52, an undesirable formation of creases may be prevented without the application of excessive pressure. The distance of the belt faces 33, 34 needs to be adapted to the respective application in dependence on the substrate thickness, on the pressure to be applied, etc., with means which are known per se.

The heating elements and/or cooling elements may be immovably fixed in the belt press module 3. Alternatively, they may be movable in a direction perpendicular to the plane of the laminate in order to process different laminate thicknesses or in order to execute a thickness compensation. In the latter variant, a travel of the heating elements and/or cooling elements may be adjustable. The heating elements and/or cooling elements may also be elastically mounted, and the directional quantity (spring rate) may be adjustable. The heating elements and/or cooling elements may be movable separately or in groups of several mechanically connected heating elements and/or cooling elements. It is also possible to provide movable heating elements and/or cooling elements which are lockable in a certain position. Corresponding means for movably mounting the heating elements and/or cooling elements may be mechanical, pneumatic, hydraulic and/or electromagnetic.

The pressure for connecting and fixing the two two-dimensional materials 51, 52 may be reduced on processing particularly pressure-sensitive materials 51, 52 in that the upper belt face 34 is held up without contact. This may be effected e.g. magnetically or pneumatically (by suctioning). The sagging of the upper belt face 34 is alleviated by way of this, and an undesired high compression loading of the materials 51, 52 to be connected is avoided.

In the case that the belt press station 30 is not to be applied, bypass paths 71, 72 for the two materials webs 51, 52 are provided. These in the present embodiment example run below the belt press station 30 and are shown in FIG. 1 as phantom lines. The possibility of bypassing the belt press station 30 increases the flexibility of the field of application of the device 1 according to the invention.

Although the embodiment example represented in the drawings relates to flexible sheet formations 51, 52 such as textile material webs, the invention is also suitable for connecting rigid or stiff substrates such as steel, aluminum plate veneering, plastics or nonwovens. Thus a rigid plate as a second, two-dimensional material 52 may be introduced into the calendar 26 which is arranged in entry region of the belt press module 3. In the case that the rigid, two-dimensional material 52 is plane, the belt faces 33, 34 of the belt press station 30 need to have a straight course.

The hot-melt module 2 and the belt press module 3 may be expanded by further modules (not drawn in). These further modules may be arranged in front of, between and/or after the modules 2, 3 discussed above. Such further modules may e.g. be an intermediate storage means, a cutting station, a transport table, a winding station and/or an unwinding station.

One may provide a platform 81 and an operating unit 82 for operating persons 80.

### LIST OF REFERENCE NUMERALS

1 device
2 hot-melt module
20 hot-melt mass deposition station
21 gravure roller
22 doctor beam
23 doctor blade
24 counter roller
25 post-heating element
26 calendar
3 belt press module
30 belt press station
31, 32 transport belts
33, 34 belt faces
35 press heating element
36 preheat element
4 module delimitation
51, 52 first and second, two-dimensional material
53 laminate
61, 62 unwinding stations
71, 72 bypass paths
80 operating person
81 platform
82 operating unit

1. A method for connecting two-dimensional materials, wherein
a surface of a first, two-dimensional material is coated with a hot-melt mass and is brought into contact with a surface of a second, two-dimensional material,
characterized in that
the contact between the two, two-dimensional materials is fixed in a belt press.

2. The method according to claim 1, wherein the hot-melt mass is deposited onto the surface of the first, two-dimensional material by way of a rotation deposition body, a slot die, with a rotation screen printing method or with a melt-blow method.

3. The method according to claim 2, wherein the hot-melt mass is deposited onto the surface of the first, two-dimensional material by way of a rotation deposition body, whose surface comprises a structure and is [closed-loop] controlled in temperature, in that
the first, two-dimensional material is led past the rotation deposition body with transfer contact with a transport speed,
the rotation deposition body is rotated at a rotational speed,
the hot-melt mass is melted and is brought into the surface structure of the rotation deposition body and the surface of the rotation deposition body is brought into contact with the first, two-dimensional material, so that at least a part of the hot-melt mass is deposited from the surface structure of the rotation deposition body onto the surface of the first, two-dimensional material, wherein
at the contact location of the rotation deposition body and the first, two-dimensional material, the speed of the surface of the rotation deposition body and the speed of the first, two-dimensional material are different to one another.

4. The method according to claim 3, wherein at the contact location of the rotation deposition body and of the first, two-dimensional material, the surface of the rotation deposition body, and the first, two-dimensional material are moved in the same direction, and wherein the ratio of the speed of the surface of the rotation deposition body to the speed of the first, two-dimensional material is preferably selected between 0.1 and 10.

5. The method according to claim 3, wherein at the contact location of the rotation deposition body and of the first, two-dimensional material, the surface of the rotation deposition body and the first, two-dimensional material are moved in opposite directions, and wherein the ratio of the speed of the surface of the rotation deposition body to the speed of the first, two-dimensional material is preferably selected between −0.2 and −5.

6. The method according to claim 3, wherein a gravure roller or a rotation screen printing stencil is used as a rotation deposition body.

7. A device for connecting two-dimensional materials, containing
coating means for coating a surface of a first, two-dimensional material with a hot-melt mass and
contacting means for contacting the coated surface of the first, two-dimensional material with a surface of a second, two-dimensional material,
characterized by
a belt press for fixing the contact between the two, two-dimensional material.

8. The device according to claim 7, wherein the coating means contain a rotation deposition body, a slot die, a rotation screen printing unit or a melt-blow unit.

9. The device according to claim 7, wherein the coating means contain a rotation deposition body whose surface has a structure and may be [closed-loop] controlled in temperature, comprising
first drive means for driving the rotation deposition body in a manner such that it may be rotated with a rotational speed,
introduction means for introducing molten hot-melt mass into the surface structure of the rotation deposition body,
transport means by way of which the first, two-dimensional material may be led past the rotation deposition body in a manner such that the surface of the rotation deposition body may be brought into contact with the surface of the first, two-dimensional material, and
second drive means for conveying the first, two-dimensional material in a manner such that the first, two-dimensional material may be transported past the rotation deposition body with a transport speed,
wherein
the first drive means and the second drive means may be set in a manner such that at the contact location of the rotation deposition body and of the first, two-dimensional material, the speed of the surface of the rotation deposition body and the speed of the first, two-dimensional material are different to one another.

10. The device according to claim 9, wherein the rotation deposition body is designed as a gravure roller or as a rotation screen printing stencil.

11. The device according to claim 7, wherein the belt press comprises two transport belts arranged essentially above one another, wherein two belt faces of the transport belts are directed facing one another and run essentially parallel to one another.

12. The device according to claim 11, wherein the belt faces have a straight course, a simple curved course, a multiple curved course, or a combination thereof.

13. The device according to claim 7, wherein the belt press contains at least one heating element and/or at least one cooling element.

14. The device according to claim 7, wherein a calendar is arranged upstream of the belt press.

15. The device according to claim 7, wherein the coating means are accommodated in a hot-melt module, and the belt press in a belt-press module, said both modules being autonomous and in each case comprising a well-defined interface for the transfer of the coated, first, two-dimensional material.

16. The method according to claim 4, wherein a gravure roller or a rotation screen printing stencil is used as a rotation deposition body.

17. The method according to claim 5, wherein a gravure roller or a rotation screen printing stencil is used as a rotation deposition body.

18. The device according to claim 8, wherein the belt press comprises two transport belts arranged essentially above one another, wherein two belt faces of the transport belts are directed facing one another and run essentially parallel to one another.

19. The device according to claim 9, wherein the belt press comprises two transport belts arranged essentially above one another, wherein two belt faces of the transport belts are directed facing one another and run essentially parallel to one another.

20. The device according to claim 10, wherein the belt press comprises two transport belts arranged essentially above one another, wherein two belt faces of the transport belts are directed facing one another and run essentially parallel to one another.

21. The device according to claim 20, wherein the belt faces have a straight course, a simple curved course, a multiple curved course, or a combination thereof.

22. The device according to claim 12, wherein:
the belt press contains at least one heating element and/or at least one cooling element;
a calendar is arranged upstream of the belt press;
the coating means are accommodated in a hot-melt module, and the belt press in a belt-press module, said both modules being autonomous and in each case comprising a well-defined interface for the transfer of the coated, first, two-dimensional material.

23. The device according to claim 21, wherein:
the belt press contains at least one heating element and/or at least one cooling element;
a calendar is arranged upstream of the belt press;
the coating means are accommodated in a hot-melt module, and the belt press in a belt-press module, said both modules being autonomous and in each case comprising a well-defined interface for the transfer of the coated, first, two-dimensional material.
